(19) United States
(12) Patent Application Publication
(10) Pub. No.: US 2020/0279570 A1
(43) Pub. Date: Sep. 3, 2020

(54) SPEAKER DETERMINATION APPARATUS, SPEAKER DETERMINATION METHOD, AND CONTROL PROGRAM FOR SPEAKER DETERMINATION APPARATUS

(71) Applicant: Konica Minolta Inc., Tokyo (JP)

(72) Inventor: Yoshimi NAKAYAMA, Tokyo (JP)

(21) Appl. No.: 16/780,979

(22) Filed: Feb. 4, 2020

(30) Foreign Application Priority Data
Mar. 1, 2019 (JP) 2019-037625

(51) Int. Cl. G10L 17/26; H04R 29/00; G10L 15/04; G10L 15/26

(52) U.S. Cl. CPC G10L 17/26; G10L 15/265; G10L 15/04; H04R 29/007

(57) ABSTRACT

A speaker determination apparatus includes a hardware processor that: acquires data related to voice in a conference; determines whether the voice has been switched in accordance with a feature amount of the voice extracted from the data related to the voice acquired by the hardware processor; recognizes and converts the voice into text in accordance with the data related to the voice acquired by the hardware processor; analyzes the text converted by the hardware processor and detects a sentence break in the text; and determines a speaker in accordance with timing of the sentence break detected by the hardware processor and timing of the voice switching determined by the hardware processor.

The entire disclosure of Japanese patent Application No. 2019-037625, filed on Mar. 1, 2019, is incorporated herein by reference in its entirety.

### BACKGROUND

### Technological Field

The present invention relates to a speaker determination apparatus, a speaker determination method, and a control program for the speaker determination apparatus.

### Description of the Related art

Various techniques for determining a speaker in accordance with voice data and outputting a journal have been known heretofore. For example, JP 2018-45208 A discloses a system for determining a speaker in accordance with voice data input to a microphone attached to each speaker and displaying a journal.

However, the system disclosed in JP 2018-45208 A assumes that a microphone is attached to each speaker and the voice of each speaker is basically input to each microphone to acquire voice data of each speaker. If no microphone is attached individually to each speaker, the speaker would not be determined properly.

In particular, a speaker does not always speak at a constant tone, but sometimes speaks weakly at the beginning or ending of a sentence, while selecting or thinking about a word. It is also likely that, before a speaker finishes speaking, another speaker may interrupt and start speaking, or noise may be generated. With such a system disclosed in JP 2018-45208 A, it is difficult to determine who the speaker is when no microphone is attached to each speaker.

### SUMMARY

The present invention has been made in view of the above-described problem. Therefore, it is an object of the present invention to provide a speaker determination apparatus, a speaker determination method, and a control program for the speaker determination apparatus, to discriminate and determine a speaker with high accuracy without attaching a microphone to each speaker.

To achieve the abovementioned object, according to an aspect of the present invention, a speaker determination apparatus reflecting one aspect of the present invention comprises: a hardware processor that: acquires data related to voice in a conference; determines whether the voice has been switched in accordance with a feature amount of the voice extracted from the data related to the voice acquired by the hardware processor; recognizes and converts the voice into text in accordance with the data related to the voice acquired by the hardware processor; analyzes the text converted by the hardware processor and detects a sentence break in the text; and determines a speaker in accordance with timing of the sentence break detected by the hardware processor and timing of the voice switching determined by the hardware processor.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a block diagram illustrating a schematic configuration of a user terminal according to an embodiment of the present invention;

FIG. 2 is a functional block diagram of a controller;

FIG. 3 is a flowchart illustrating a processing procedure of the user terminal;

FIG. 4A illustrates an example of a screen displayed on the user terminal;

FIG. 4B illustrates an example of a screen displayed on the user terminal;

FIG. 5 is a subroutine flowchart illustrating a procedure of speaker switching determination processing in step S107 of FIG. 3;

FIG. 6A is a subroutine flowchart illustrating a procedure of speaker determination processing in step S109 of FIG. 3;

FIG. 6B is a subroutine flowchart illustrating a procedure of speaker determination processing in step S109 of FIG. 3;

FIG. 7A is a diagram for explaining speaker determination processing;

FIG. 7B is a diagram for explaining speaker determination processing;

FIG. 7C is a diagram for explaining the speaker determination processing;

FIG. 7D is a diagram for explaining the speaker determination processing; and

FIG. 8 is a diagram illustrating an overall configuration of a speaker determination system.

### DETAILED DESCRIPTION OF EMBODIMENTS

Hereinafter, one or more embodiments of the present invention will be described with reference to the drawings. However, the scope of the invention is not limited to the disclosed embodiments. In the description of the drawings, the same elements are denoted by the same reference signs and are not described repeatedly. In addition, the scale ratio of the drawings is exaggerated for convenience of description and may be different from the actual scale ratio.

First, a user terminal that works as a speaker determination apparatus according to an embodiment of the present invention is described.

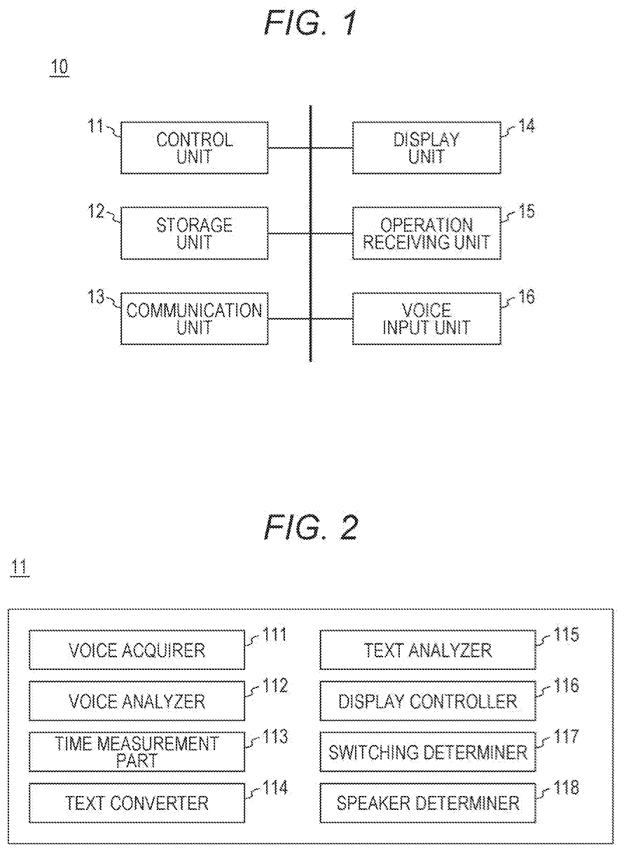

FIG. 1 is a block diagram illustrating a schematic configuration of a user terminal according to an embodiment of the present invention.

As illustrated in FIG. 1, the user terminal 10 includes a controller 11, a storage part 12, a communication part 13, a display part 14, an operation receiving part 15, and a voice input part 16. The constituent components are connected to each other via a bus for exchanging signals. The user terminal 10 is, for example, a notebook or desktop PC terminal, a tablet terminal, a smartphone, a mobile phone, or the like.

The controller 11 includes a central processing unit (CPU), and executes control of individual constituent components described above and various kinds of arithmetic processing according to a program. The functional configuration of the controller 11 will be described later with reference to FIG. 2.

A storage part 12 includes a read only memory (ROM) that previously stores various programs and various kinds of data, a random access memory (RAM) that functions as a work area to temporarily store programs and data, a hard disk that stores various programs and data, and the like.

The communication part 13 includes an interface for communicating with other devices via a network such as a local area network (LAN).

The display part 14, which works as an outputter, includes a liquid crystal display (LCD), an organic EL display, and the like, and displays (outputs) various kinds of information.

The operation receiving part 15 includes a keyboard, a pointing device such as a mouse, a touch sensor, or the like, and receives various operations. The operation receiving part 15 receives, for example, a user input operation on the screen displayed on the display part 14, for example.

The voice input part 16 includes a microphone or the like and accepts input of outside voice and the like. Note that the voice input part 16 may not include the microphone itself, and may include an input circuit for receiving voice input via an external microphone or the like.

Note that the user terminal 10 may include constituent components other than those described above, or may not necessarily include all constituent components described above.

Next, the functional configuration of the controller 11 is described,

FIG. 2 is a block diagram illustrating a functional configuration of the controller.

As illustrated in FIG. 2, the controller 11 reads the program and executes processing, and working as a voice acquirer 111, a voice analyzer 112, a time measurement part 113, a text converter 114, a text analyzer 115, a display controller 116, a switching determiner 117, and a speaker determiner 118.

The voice acquirer 111 acquires data related to voice (hereinafter also referred to as “voice data”). The voice analyzer 112 performs voice analysis in accordance with the voice data, that is, analysis in accordance with a feature amount of the voice extracted from the voice data, and temporarily determines the speaker who has uttered the voice. The time measurement part 113 measures time and determines regarding time. The text converter 114 recognizes voice in accordance with the voice data using a known voice recognition technique, and converts the voice into text (text generation). The text analyzer 115 analyzes the text, makes a determination n accordance with the text, and detects a sentence break in the text. The display controller 116 displays various kinds of information on the display part 14. The switching determiner (voice switching determiner) 117 determines whether the voice is switched, that is, whether the voice is switched to a voice having a different feature amount. More specifically, the switching determiner 117 determines whether the voice is switched by determining whether the voice of a speaker who has been temporarily determined has been switched to the voice of another speaker, and therefore, whether a speaker who has been temporarily determined has been switched to another speaker. The speaker determiner 118 formally determines the speaker in accordance with the sentence break timing and the switching timing of the voice and, therefore, the speaker.

Note that an external device such as a server may function as the speaker determination apparatus in place of the user terminal 10 by implementing at least part of the functions described above. In this case, the external device such as a server may be connected to the user terminal 10 in a wired or wireless manner to acquire voice data from the user terminal 10.

Subsequently, a processing flow in. the user terminal 10 is described. The processing in the user terminal 10 discriminates and determines the speaker with high accuracy without attaching a microphone to each speaker.

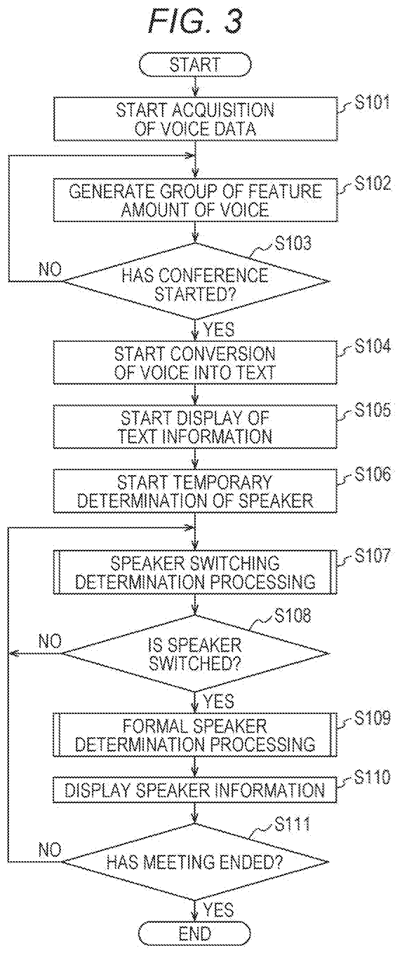

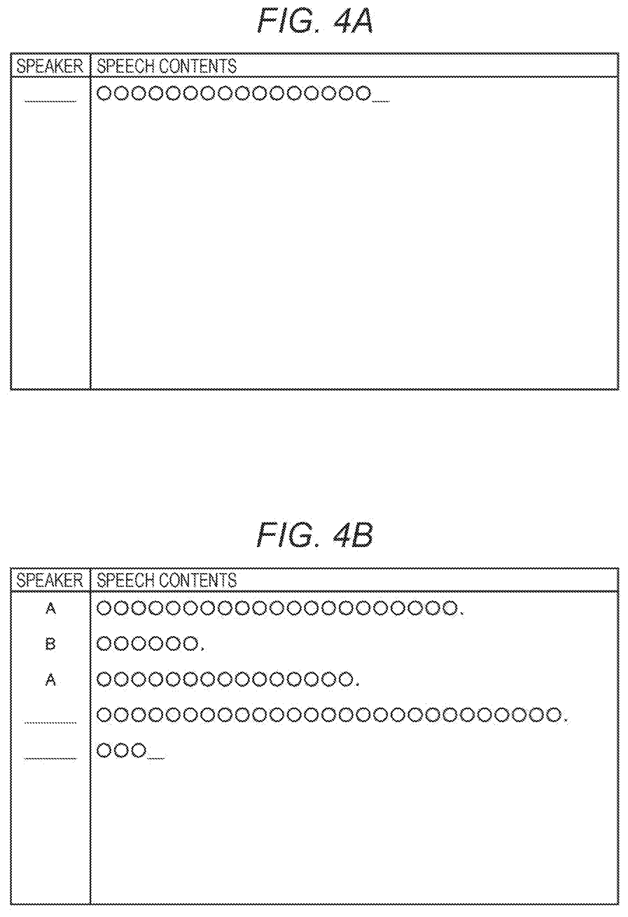

FIG. 3 is a flowchart illustrating a processing procedure of the user terminal. FIGS. 4A and 4B are diagrams each illustrating an example of a screen displayed on the user terminal A processing algorithm illustrated in FIG. 3 is stored as a program in the storage part 12 and is executed by the controller 11.

As illustrated in FIG. 3, first, the controller 11 starts execution of processing for acquiring voice data as the voice acquirer 111 before the conference starts (step S101). For example, the controller 11 acquires, for example, data related to voices of conference participants input to the voice input part 16 before the start of the conference, such as voices of speakers during greeting, chatting, counting, and the like, voices of speakers while confirming connection of instruments, and the like.

Subsequently, the controller 11 extracts, as the voice analyzer 112, a feature amount of the voice in accordance with the acquired voice data, and generates a group of feature amounts of the voice for each speaker in accordance with the extracted voice feature amount (step S102). More specifically, the controller 11 extracts, for example, Mel frequency Cepstrum coefficient (MFCC), format frequency, or the like, as the feature amount of the voice. Then, the controller 11 performs, for example, well-known cluster analysis on the extracted feature amounts of the voice, and generates a group of feature amounts of the voice for each speaker in descending order front the highest similarity (or matching degree) (or the smallest difference). For example, the controller 11 may classify the feature amounts of the voice having similarity higher than (or a difference smaller than) a predetermined threshold into the same group as the feature amounts of the voice of the same speaker. The controller 11 may store the generated group of voice feature amounts in the storage part 12.

Subsequently, the controller 11 determines whether the conference has started (step S103). For example, the controller 11 determines, as the time measurement part 113, whether a predetermined first time has passed after the acquisition of the voice data in step S101, and may determine, upon determining that the first time has passed, that the conference has started. The first time may be, for example, several minutes. Further, the controller 11 determines whether the operation receiving part 15 has received a user operation indicating the start of the conference, and may determine, upon determining that the user operation is received, that the conference has started.

Further, the controller 11 determines whether a predetermined word indicating the start of the conference has been uttered, and may determine, upon determining that the word indicating the start of the conference has been uttered, that the conference has started. More specifically, the controller 11 may start, as the text converter 114, immediately after step S101, execution of processing for recognizing voice in accordance with the voice data and converting the voice data into text. Further, the controller 11 may start execution of processing for analyzing the converted text as the text analyzer 115. Then, the controller 11 determines whether any speaker has uttered a word indicating the start of the conference, and may determine, upon determining that the word indicating the start of the conference has been uttered, that the conference has started. The storage part 12 previously stores a table or list including words indicating the start of the conference, and the controller 11 may determine whether a word included in the table or list has been uttered.

When it is determined that the conference has not started (step S103: NO), the controller 11 returns to the processing of step S102. Then, the controller 11 repeats execution of the processing of steps S102 and S103 until the start of the conference is determined. That is, as preliminary processing before the start of the conference, the controller 11 repeats execution of processing for generating a group of feature amounts of tile voice for each speaker according to tile similarity among a plurality of feature amounts of the voice. Preferably, the number of groups of tile voice feature amounts for each speaker equals to a number corresponding to the number of participants in the conference, and the controller 11 may previously obtain information on the number of participants in the conference and generate the number of groups corresponding to the number of participants. However, if some participants do not speak during the time from the start of acquisition of the voice data in step S101 to the start of the conference, the number of groups of the voice feature amounts for each speaker may not correspond to the number of participants in the conference.

Upon determination of the start of the conference (step S103: YES), the controller 11 starts, as the text converter 114, execution of the processing for recognizing the voice in accordance with the voice data and converting the voice into text (step S104). The voice data is continuously acquired from step S101, and is acquired as voice data during the conference in step S101 Note that the controller it may omit the processing of step S104 if the processing similar to the processing of step S104 has been started immediately after step S101 to determine the start of the conference. Then, the controller 11 starts, as the display controller 116, execution of processing for displaying information related to the converted text (hereinafter also referred to as “text information”) on the display part 14 (step S105). For example, as illustrated in FIG. 4A, the display part 14 displays text information of speech contents in real time.

Subsequently, the controller 11 extracts, as the voice analyzer 112, a voice feature amount in accordance with the voice data during the conference, and starts execution of processing for extracting the voice feature amount and temporarily determining a speaker in accordance with the extracted voice feature amount (step S106). More specifically, the controller 11 temporarily determines the speaker by identifying a group corresponding to the extracted voice feature amount (or including the extracted voice feature amount) among the previously-generated groups of the voice feature amount for each speaker in step S102.

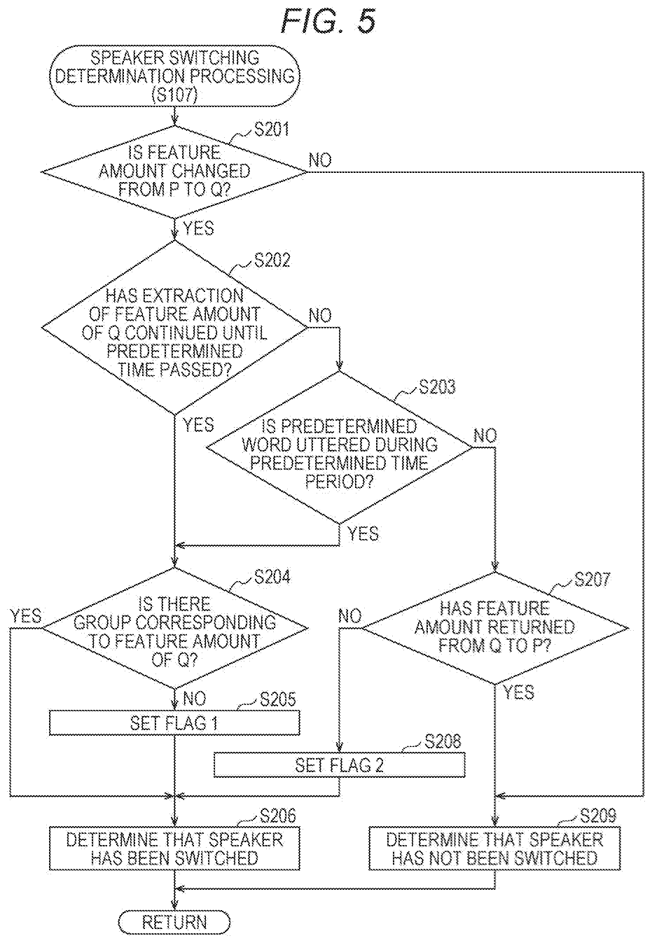

Subsequently, the controller 11 executes speaker switching determination processing (step S107). Details of the processing in step S107 will be described later with reference to FIG. 5. Then, the controller 11 determines whether the temporarily determined speaker has been switched in accordance with the determination result of step S107 (step S108).

If it is determined that the speaker has not been switched (step S108: NO), the controller 11 repeats execution of the processing of steps S107 and S108 until the switching of the speaker is determined.

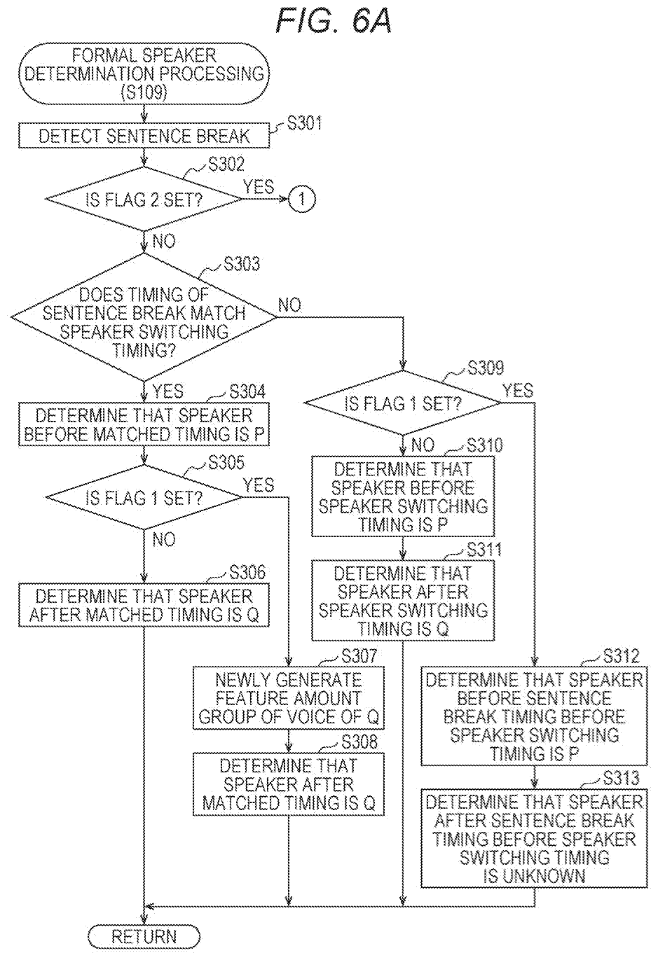

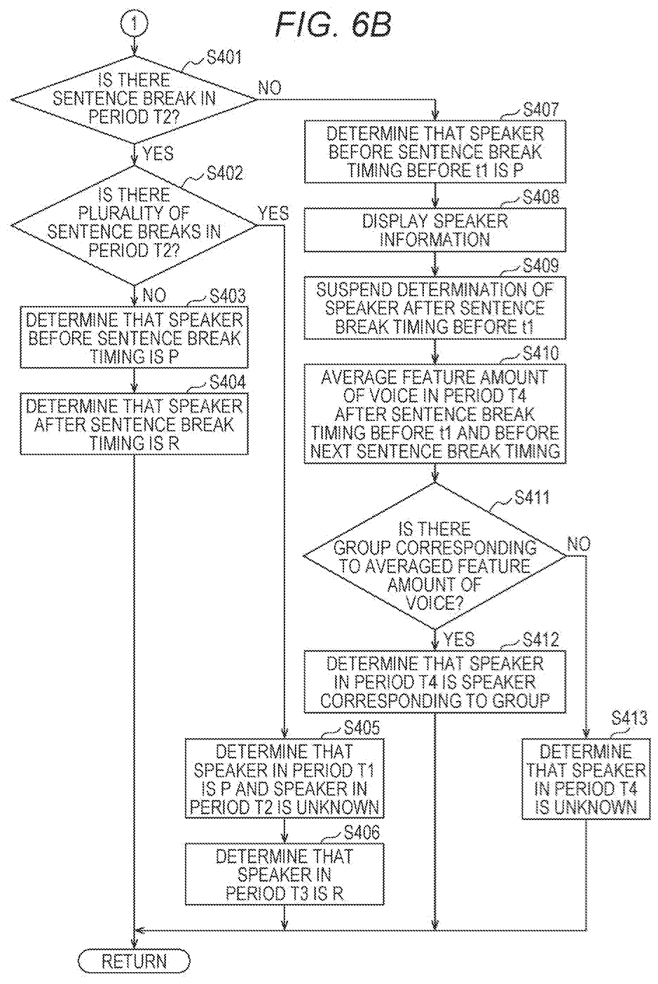

If it is determined that the speaker has been switched (step S108: YES), the controller 11 executes formal speaker determination processing (step S109). Details of the processing in step S109 will be described later with reference to FIGS. 6A and 6B. Then, the controller 11 displays, as the display controller 116, information related to the speaker determined in step S109 (hereinafter also referred to as “speaker information”) on the display part 14 in association with the displayed text information (step S110).

Subsequently, the controller 11 determines whether the conference ends (step S111). For example, like step S103, the controller 11 determines whether the operation receiving part 15 has received a user operation indicating the end of the conference, and may determine, upon determining that the user operation is received, that the conference has ended. Further, the controller 11 may determine whether a predetermined word indicating the end of the conference has been uttered, and may determine, upon determining that the word indicating the end of the conference has been uttered, that the conference has ended. The storage part 12 previously stores a table or list including words indicating the finishing of the conference, and the controller 11 may determine whether a word included in the table or list has been uttered.

When it is determined that the conference has not ended (step S111: NO), the controller 11 returns to the processing of step S107. Then, the controller 11 repeatedly executes the processing of steps S107 to S111 until the end of the conference is determined. That is, as illustrated in FIG. 4B, for example, as soon as the speaker is determined, the controller 11 repeatedly executes the processing of associating the speaker information with the text information and displaying the information on the display part 14 in real time. Accordingly, the journal in which the speaker information is associated with the text information is displayed. FIG. 4B illustrates the situation in which the speaker corresponding to the text information in the first and third lines is determined to be A, the speaker corresponding to the text information in the second line is determined to be B, but no speaker has been determined corresponding to the text information in the fourth and fifth lines. In the example illustrated in FIG. 4B, the speaker information is displayed as information about the speaker classification name such as A, B, . . . , but how the speaker information is displayed is not limited to the example illustrated in FIG. 4B. For example, the controller 11 may control the display part 14 so as to display information related to the name of the speaker, display text information corresponding to each speaker by color-coding, or display text information corresponding to each speaker in word balloons. The controller 11 may acquire information related to the name of the speaker by displaying an input screen for inputting the name of the speaker on the display part 14, and accepting the user operation of inputting information related to the name of the speaker by the operation receiving part 15.

When it is determined that the conference has ended (step S111 YES), the controller 11 terminates the processing illustrated in FIG. 3.

Next, details of the speaker switching determination processing in step S107 is described.

FIG. 5 is a subroutine flowchart illustrating the procedure of speaker switching determination processing in step S107 of FIG. 3.

As illustrated in FIG. 5, first, the controller 11 determines, as the voice analyzer 112, whether the voice feature amount extracted as the voice feature amount of the temporarily determined speaker has been changed from the voice feature amount of one speaker to a different voice feature amount of another speaker (step S201).

Hereinafter, for convenience of explanation, one speaker is referred to as a speaker P (first speaker) and another speaker is referred to as a speaker Q (second speaker).

When it is determined that the voice feature amount has changed from the voice feature amount of the speaker P to the voice feature amount of the speaker Q (step S201: YES), the controller 11 proceeds to the processing of step S202. For example, if the situation changes from a state where the feature amount of the extracted voice is included in the group of the voice feature amount of the speaker P, which is previously generated in step S102, to a state not included, the controller 11 determines that the voice feature amount has changed from the voice feature amount of the speaker P. Then, the controller 11 determines, as the time measurement part 113, whether the extraction of the voice feature amount of the speaker Q has continued until a predetermined second time has passed (step S202). The second time may be, for example, several hundred ms to several seconds.

If it is determined that the extraction of the voice feature amount of the speaker Q has not continued (step S202: NO), the controller 11 proceeds to the processing of step S203. For example, when it is determined that the voice feature amount of the extracted voice has further changed from the feature amount of the voice of the speaker Q to the feature amount of the voice of another speaker before the second time has passed, the controller 11 determines that the extraction of the voice feature amount of the speaker Q has not continued. Then, the controller 11 analyzes, as the text analyzer 115, the text in the second time including the period during which the feature amount of the voice of the speaker Q is extracted, and determines whether a predetermined word has been uttered during the second time (step S203). The predetermined word may be, for example, a word. For nodding, such as “yes” or “well”, or a short sentence including a response such as “so?”. The storage part 12 previously stores a table or list including a predetermined word, and the controller 11 may determine whether the predetermined word included in the table or list has been uttered.

When it is determined that the predetermined word has been uttered (step S203: YES), or when it is determined that extraction of the feature amount of the voice of the speaker Q has continued (step S202: YES), the controller 11 proceeds to processing of step S204. Then, the controller 11 determines, as the voice analyzer 112, whether there is a group corresponding, to the voice feature amount of the speaker Q among time previously-generated groups of voice feature amount for each speaker in step S102 (step S204).

When it is determined that there is no group corresponding to the voice feature amount of the speaker Q (step S204: NO), the controller 11 sets a flag 1 (step S205) and proceeds to the processing of step S206. That is, the flag 1 is a flag indicating that a new speaker Q who has not been subjected to clustering (or no group corresponds to the voice feature amount) is found. On the other hand, when it is determined that there is a group corresponding to the voice feature amount of the speaker Q (step S204: YES), the controller 11 proceeds straight to the processing of step S206. Then, the controller 11 determines, as the switching determiner 117, that the speaker has been switched at the timing when it is determined in step S201 that the voice feature amount has changed (step S206). In this case, the controller 11 determines that the speaker has been switched from the speaker P to the speaker Q. After that, the controller H returns to the processing illustrated in FIG. 3.

Meanwhile, when it is determined that no predetermined word has been uttered (step S203: NO), the controller 11 proceeds to the processing of step S207. Then, the controller 11 determines, as the voice analyzer 112, whether the extracted voice feature amount has returned (changed) from the voice feature amount of the speaker Q to the voice feature amount of the speaker P (step S207).

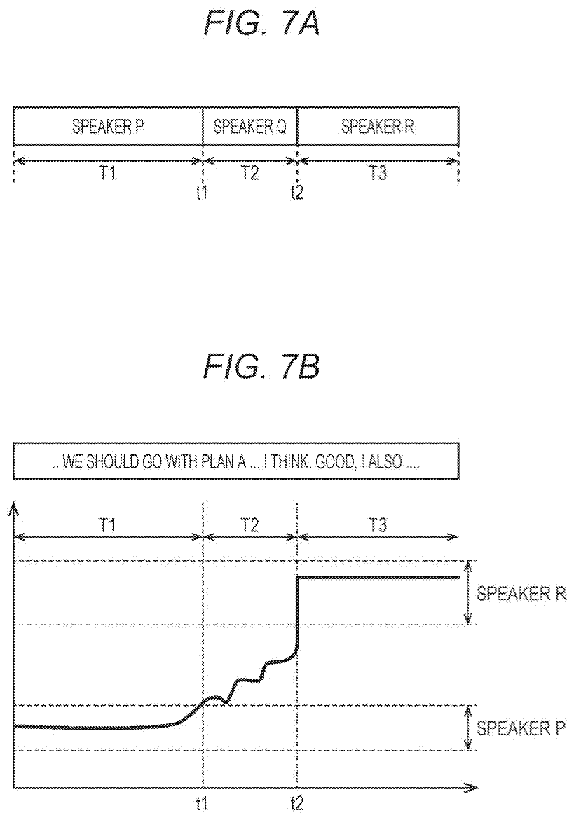

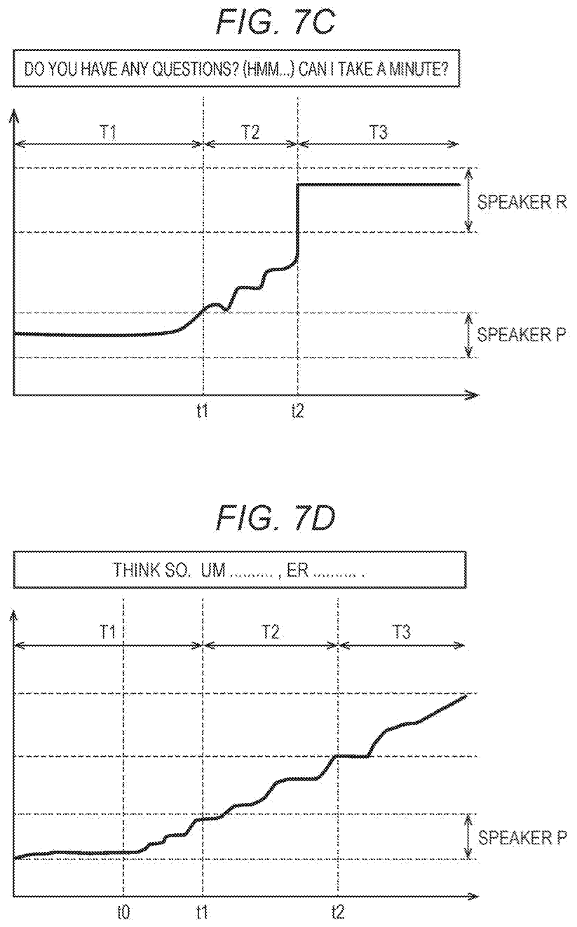

When it is determined that the voice feature amount has not returned to the voice feature amount of the speaker P, but has further changed to the voice feature amount of a new speaker (step S207: NO), the controller 11 sets a flag 2 (step S208). That is, as illustrated in FIGS. 7B to 7D, which will be described later, the flag 2 is a flag that indicates the need for detailed analysis afterward because the speaker is not clearly switched as being switched while the voice changes gradually or there are ambiguous expressions. In the following, a new speaker is referred to as speaker R (third speaker). Then, the controller 11 determines, as the switching determiner 117, that the speaker has been switched (step S206). After that, the controller 11 returns to the processing illustrated in FIG. 3.

When it is determined that the voice feature amount has returned to the voice feature amount of speaker P (step S207: YES), or that the voice feature amount of speaker Q has not changed at all (step S201: NO), the controller it proceeds to the processing of step S209. Then, the controller 11 determines, as the switching determiner 117, that the speaker has not been switched (step S209). After that, the controller 11 returns to the processing illustrated in FIG. 3.

Next, details of the speaker determination processing in step S109 is described.

FIGS. 6A and 6B are subroutine flowcharts illustrating the procedure of the speaker determination processing in step S109 of FIG. 3. FIGS. 7A to 7D are diagrams for explaining the speaker determination processing. In FIGS. 7B to 7D, the horizontal axis indicates time, the vertical axis indicates voice feature amounts, and broken lines parallel to the horizontal axis exemplify regions corresponding to the groups of voice feature amounts for each speaker.

As illustrated in FIG. 6A, first, the controller it analyzes, as the analyzer 115, the converted text and detects a sentence break in the text (step S301).

The controller 11 detects the sentence break in accordance with a silent part in the text. For example, the controller 11 may detect the silent part that continues for at least a predetermined time as the sentence break. More specifically, the controller 11 detects, as the sentence break, for example, the silent part corresponding to immediately after the end of a sentence indicated by a punctuation mark in the case of Japanese, or the silent part corresponding to immediately after the end of a sentence indicated by a period in English.

Further, the controller 11 may detect the sentence break in accordance with the structure of a sentence in the text. For example, the controller 11 may detect the sentence break before and after a sentence configured according to correct grammar that has been grasped previously, that is, a sentence configured with a correct word order of a subject, a predicate, an object, and so on. More specifically, the controller 11 detects the sentence break before and after a complete sentence such as “I will do it.”, “He likes running.”, or the like in English, for example. Alternatively, the words like “Definitely!”, “Good.”, or the like are regarded as a sentence when used alone, so that the controller 11 may detect the sentence break before and after these words. On the other hand, the controller 11 does not detect the sentence break in a case of “I make”, “Often we”, “Her delicious” or the like, because such words apparently miss a predicate, an object, and so on, and the sentence may continue after these words. Note that the method for detecting the sentence break is not limited to the examples described above.

Subsequently, the controller 11 determines whether the flag 2 has been set by the speaker switching determination processing of step S107 that has been executed immediately before the present step (step S302).

When it is determined that no flag 2 has been set (step S302: NO), the controller 11 proceeds to the processing of step S303. This case corresponds to a case where it is determined that the speaker is switched from the speaker P to the speaker Q in the speaker switching determination processing in step 5107. Then, the controller 11 determines, as the speaker determiner 118, whether the sentence break timing detected in step S301 matches the speaker switching timing determined in step S107 (step S303). Even when the sentence break timing is deviated from the speaker switching timing, the controller 11 may determine that the timing is matched on the condition that the deviation amount is within a period of a predetermined third time. The third time may be, for example, several hundred ms.

When it is determined that the sentence break timing and the speaker switching timing match (step S303: YES), the controller 11 proceeds to the processing of step S304. Then, the controller 11 determines, as the speaker determiner 118, that the speaker has been switched at the matched timing, and that the speaker before the matched timing is the speaker P (step S304). This case corresponds to a case, for example, where the speaker is switched smoothly from the speaker P to the speaker Q as the speaker Q starting to speak and respond to the speaker Q after the speaker P has finished speaking. Then, the controller 11 determines whether the flag 1 has been set by the speaker switching determination processing of step S107 executed immediately before the present step (step S305).

When it is determined that no flag 1 has been set (step S305: NO), the controller 11 proceeds to the processing of step S306. Then, the controller 11 determines, as the speaker determiner 118, that the speaker after the matched timing (the sentence break timing and the speaker switching timing) is the speaker Q whose feature amount group of own voice has previously been generated (step S306). After that, the controller 11 returns to the processing illustrated in FIG. 3.

When it is determined that that the flag 1 has been set (step S305: YES), the controller 11 generates, as the voice analyzer 112, a new voice feature amount group of the speaker Q (step S307). Then, the controller 11 determines, as the speaker determiner 118, that the speaker after the matched timing is the speaker Q whose feature amount group of own voice has newly been generated (step S308). As described above, the controller 11 determines that the speaker after the switching is the speaker Q who has not spoken so far when the sentence break timing and the speaker switching timing match, although no voice feature amount group has been generated for the speaker Q. After that, the controller 11 returns to the processing illustrated in FIG. 3.

On the other hand, when it is determined that the sentence break timing and the speaker switching timing do not match (step S303: NO), the controller 11 proceeds to the processing of step S309. Then, like step S305, the controller 11 determines whether the flag 1 has been set by the speaker switching determination processing of step S107 executed immediately before the present step (step S309).

When it is determined that no flag 1 has been set (step S309: NO), the controller 11 determines, as the speaker determiner 118, that the speaker before the speaker switching liming is the speaker P (step S310). Further, the controller 11 determines that the speaker after the speaker switching timing is the speaker Q (step S310. This case corresponds to a case, for example, where, before the speaker P finishes speaking, the other speaker Q whose feature amount group of own voice has previously been generated as interrupted and started speaking, so that the speaker P has not been switched smoothly to the speaker Q. Thus, even when the sentence break timing and speaker switching timing do not match, but when the voice feature amount group of the speaker Q has previously been generated, the controller 11 prioritizes the speaker switching timing and determines that the speaker after the switching timing is the speaker Q. After that, the controller 11 returns to the processing illustrated in FIG. 3.

When it is determined that flag 1 has been set (step S309: YES), the controller 11. determines, as the speaker determiner 118, that the speaker before the sentence break timing, provided before the speaker switching timing is the speaker P (step S312). Further, the controller 11 determines that the speaker is unknown after the sentence break timing of the sentence (step S313). This case corresponds to a case, for example, where the speaker has not been smoothly switched from the speaker P due to noise generated before the speaker P finishes speaking. Thus, when the speaker cannot be determined clearly, the controller 11 avoids erroneous determination of the speaker and determines that the speaker is unknown. After that, the controller 11 returns to the processing illustrated in FIG. 3.

Note that the controller 11 may reset the flag 1 after steps S308 or S313 and before returning to the processing illustrated in FIG. 3.

On the other hand, when it is determined that the flag 2 has been set (step S302: YES), the controller It proceeds to the processing illustrated in FIG. 6B. This case corresponds to a case where there is a possibility that the speaker has been switched from the speaker P to a speaker R. in the following, as illustrated in FIG. 7A. it is assumed that first timing t1 indicates timing at which the extracted voice feature amount changes from the voice feature amount of the speaker P to the voice feature amount of the speaker Q, and second timing t2 indicates timing at which the voice feature amount of Q changes to the voice feature amount of the speaker R. it is also assumed that a period before the first timing t1 is referred to as a period T1, a period from the first timing t1 to the second timing t2 is referred to as a period T2, and a period from the second timing t2 is referred to as a period T3.

As illustrated in FIG. 6B. first, the controller 11 determines, as the speaker determiner 118, whether a sentence break has been detected in the period T2 (step S401). That is, the controller 11 determines whether the sentence break detected. in step S301 is included in the period T2.

When it is determined that sentence break has been detected (step S401: YES), the controller 11, further determines whether a plurality of sentence breaks has been detected in the period T2 (step S402).

When it is determined that the plurality of sentence breaks has not been detected, that is, one sentence break has been detected (step S402: NO), the controller 11 proceeds to the processing of step S403. Then, the controller 11 determines, as the speaker determiner 118, that the speaker before the timing of the one sentence break is the speaker P (step S403). Further, the controller 11 determines that the speaker after the timing of the one sentence break is the speaker R (step S404). That is, the controller 11 determines that the speaker has been switched from the speaker P to the speaker R without passing through the speaker Q. This case corresponds to a case, for example, where the speaker has not been switched smoothly because the speaker P speaks the end of the sentence weakly or the speaker R speaks the beginning of the sentence weakly. After that, the controller 11 returns to the processing illustrated in FIG. 3.

Steps S403 and S404 are described further with reference to FIG. 7B. FIG. 7B illustrates a case where one clear sentence break is detected in the period T2, but the speaker is not clearly changed because the speaker P has spoken the end of the sentence weakly. In this case, it is determined that the speaker before the end timing of the sentence “. . . I think.” is the speaker P, and the speaker after the end timing of the sentence, that is, after the beginning timing of a new sentence “Good . . . ” is the speaker R, so that the speaker Q is ignored. Alternatively, rather than using the sentence break timing, the speaker may be determined by prioritizing the second timing t2 at which the voice feature amount of the speaker R is extracted. That is, the speaker in the periods T1 and T2 may be determined to be the speaker P, and the speaker in the period T3 may be determined to be the speaker R.

On the other hand, when it is determined that the plurality of sentence breaks has been detected (step S402: YES), the controller 11 proceeds to the processing of step S405. Then, the controller 11 determines, as the speaker determiner 118, that the speaker in the period T1 is the speaker P and the speaker in the period T2 is unknown (step S405). Further, the controller 11 determines that the speaker in the period T3 is the speaker R (step S406). This case corresponds to a case, for example, where the noise is generated, or the speaker Q speaks unclearly, or interrupts, tries to speak, and quickly stops speaking during the period T2. After that, the controller 11 returns to the processing illustrated in FIG. 3.

Steps S405 and S406 are further described with reference to FIG. 7C. FIG. 7C exemplifies a case where a plurality of sentence breaks is detected in the period T2 due to an unclear utterance “Hmm . . . .” and the speaker is changed unclearly. In this case, the speaker in the period T1 before the timing of the end of the sentence “. . . Do you have any questions?” is determined to be the speaker P. Further, it is determined that the speaker in the previous period T2 is unknown from the timing after the end of the above sentence to the beginning of the new sentence “Can I take a minute?”. Further, the speaker in the period T3 after the beginning timing of the new sentence is determined to be the speaker R.

Note that, before step S404 or S406, the controller 11 may determine whether there is the voice feature amount group previously generated for each speaker corresponding to the voice feature amount of the speaker R in step S102. Upon determination that no such group exist, the controller 11 may generate, like step S307 described above, a new voice feature amount group of the speaker R and proceeds to step S404 or S406.

When it is determined that no sentence break has been detected (step S401: NO), the controller 11 determines, as the speaker determiner 118, the speaker before the sentence break timing existing before the first timing t1 is the speaker P (step S407). Then, the controller if displays, as the display controller 116, the information related to the speaker determined in step S407 on the display part 14 in association with the displayed text information (step S408). Then, the controller 11 temporarily suspends, as the speaker determiner 118, the determination of the speaker after the sentence break timing of the sentence (step S409). This case corresponds to a case, for example, where the sentence break is unclear because the speaker P speaks by cheating the end of the sentence, or another speaker speaks while thinking about the beginning of the sentence.

Subsequently, the controller it averages, as the voice analyzer 112, the extracted voice feature amounts in a period (hereinafter referred to as “period T4”) between the sentence break timing existing before the first timing t1 and the timing before the next sentence break timing (step S410). Then, the controller 11 determines whether there is a group corresponding to the averaged voice feature amount among the voice feature amount groups previously generated for each speaker in step S102 (step S411).

When it is determined that there is a group corresponding to the averaged voice feature amount (step S411: YES), the controller 11 proceeds to the processing of step S412. Then, the controller 11 determines, as the speaker determiner 118, that the speaker in the period T4 is a speaker corresponding to the present group (step S412). After that, the controller 11 returns to the processing illustrated in FIG. 3.

When it is determined that there is no group corresponding to the averaged voice feature amount (step S411: NO), the controller 11 proceeds to the processing of step S413. Then, the controller 11 determines, as the speaker determiner 118, that the speaker in the period T4 is unknown (step S413). That is, the controller 11 determines that the speaker corresponding to one sentence in the period is unknown. After that, the controller 11 returns to the processing illustrated in FIG. 3.

Steps S407 to S413 are further described with reference to FIG. 7D. FIG. 7D exemplifies a case where a clear sentence break has not been detected in the period T2 and the speaker has been changed uncleanly. In this case, the speaker before the timing t0 at the end of the sentence “. . . think so.” that exists before the first timing t1 is determined to be the speaker P. The determination of the speaker after timing t0 is temporarily suspended until the next sentence break is detected, and as soon as the next sentence break is detected, the speaker is determined in accordance with the averaged voice feature amount.

Note that the controller 11 may reset the flag 2 after the processing illustrated in FIG. 6B and before returning to the processing illustrated in FIG. 3.

The present embodiment provides the following effects.

The user terminal 10 as the speaker determination apparatus detects whether the voice, and then, the speaker has been switched, while detecting the sentence break in the text in accordance with the voice data in the conference. Then, the user terminal 10 determines the speaker in accordance with the sentence break timing and the speaker switching timing. The user terminal 10 determines the sentence break timing and the speaker switching timing in accordance with. single voice data, without attaching the microphone to each speaker, thus discriminating and determining the speaker who speaks in various tones with high accuracy.

In particular, the user terminal 10 determines the speaker according to the cluster analysis of the voice feature amount, without acquiring the data related to voice through the microphone attached to each speaker or previously preparing learning data related to the voice for each speaker. Therefore, the speaker is determined without separately preparing for a memory that can previously store a large amount of learning data, an external server equipped with a processor capable of performing advanced calculations in accordance with a large amount of learning data, or the like, and the leakage of confidential information is effectively inhibited. Since the user terminal 10 does not need to perform calculations in accordance with the large amount of learning data, the processing amount is reduced, and text information and speaker information are displayed in real time.

Further, the user terminal 10 determines the speaker in accordance with the determination result of whether the sentence break timing and the speaker switching timing match. Accordingly, the user terminal 10 determines whether the sentence break timing and the speaker switching timing match in accordance with single voice data, and discriminates and determines the speaker who speaks in various tones with high accuracy.

Upon determination that the sentence break timing and the speaker switching timing match, the user terminal 10 determines the speaker before the matched timing without relying on the text analysis result. Therefore, the user terminal 10 quickly determines the speaker upon matching of the timing.

Meanwhile, upon determination that the sentence break timing and the speaker switching timing do not match, the user terminal 10 determines the speaker in accordance with the text analysis result. Accordingly, the user terminal 10 determines the speaker flexibly even when the timing deviates by the speaker speaking in various ways.

When the speaker is not determined, the user terminal 10 determines that the speaker is unknown. This prevents the error determination of the speaker by the user terminal 10.

Further, the user terminal 10 detects the sentence break in accordance with the silent part in the structure of the text or sentence. Accordingly, the user terminal 10 detects the sentence break accurately and promptly.

Further, the user terminal 10 temporarily determines the speaker who has uttered the voice and determines whether the speaker who has been determined temporarily has been switched on the basis of the voice feature amount.

Accordingly, the user terminal 10 can quickly determine whether the speaker has been switched in accordance with the temporarily determined speaker.

Further, the user terminal 10 generates the group of voice feature, amounts for each speaker before the start of the conference, and specifies the group corresponding to the extracted, voice feature amount after the start of the conference to temporarily determine the speaker. The user terminal 10 temporarily determines the speaker with high accuracy immediately after the start of the conference by previously generating the group of voice feature amounts for each speaker before the start of the conference. On the other hand, the user terminal 10 only needs to generate the group of voice feature amounts for each speaker as the conference participant, and does not need to accumulate a large amount of learning data.

Further, the user terminal 10 determines the start of the conference upon determination that the predetermined first time has passed after the start of acquisition of voice data before the conference starts. Accordingly, the user terminal 10 automatically starts execution of processing such as conversion of voice into text, temporarily determining the speaker, and the like, while previously starting acquisition of voice data before the start of the conference.

Further, the user terminal 10 determines that the conference has started upon determination that the predetermined word indicating the start of the conference has been uttered before the start of the conference. Accordingly, the user terminal 10 promptly starts execution of processing such as conversion of voice into text, temporarily determining the speaker, and the like even when the conference has started quickly before the first time has passed. As described above, the user terminal 10 accurately determine whether the conference has started from various viewpoints.

Further, when the user terminal 10 determines that the extracted voice feature amount has been changed from the voice feature amount of the first speaker (first feature amount) to the voice feature amount of the second speaker (second feature amount), but determines that there is no voice feature amount group corresponding to the second feature amount, the user terminal 10 newly generates the second feature amount group. Accordingly, when some participants do not speak during the time between the start of the acquisition of the voice data and the start of the conference, the user terminal 10 also considers such participants as speakers in the conference

Further, upon determination that the extracted voice feature amount has changed from the first feature amount to the second feature amount, and that the extraction of the second feature amount has continued until the predetermined second time has passed, the user terminal 10 determines that the speaker has been switched.

Accordingly, by considering the case where the voice feature amount of non-essential sound such as noise is extracted for a short time, the user terminal 10 determines that the speaker has been switched after confirming that the second feature amount has been extracted for a certain period of time.

Further, upon determination that the extracted voice feature amount has changed from the first feature amount to the second feature amount, and that the predetermined word, has been uttered, during the predetermined second time, the user terminal 10 determines that the speaker has been switched. Accordingly, the user terminal 10 unexceptionally determines that the speaker has been switched when, for example, the second feature amount has been extracted only for a short time, but the predetermined words including a small sentence such as nodding words have been uttered.

Further, the user terminal 10 determines whether the extracted voice feature amount has returned to the first feature amount after being changed from the first feature amount to the second feature amount, and determines whether the speaker has been switched in accordance with the determination result. Accordingly, the user terminal 10 determines that the speaker has not actually been switched, for example, after the second feature amount is extracted. only for a short time, but the first feature amount is extracted again. As described above, the user terminal 10 accurately determines whether the speaker has been switched from various viewpoints.

Further, the user terminal 10 determines whether a sentence break is detected intone above-described period T2. Upon determination that the sentence break has been detected, the user terminal 10 determines the speaker according to the number of sentence breaks. Accordingly, the user terminal 10 appropriately determines the speaker who speaks in various tones according to various conditions related to the sentence break timing and the speaker switching timing, even when the speaker has not been switched smoothly.

Further, upon determination that the sentence break has not been detected in the above-described period T2, the user terminal 10 temporarily suspends determination of the speaker after the sentence break timing existing before the first timing t1 described above. Then, the user terminal 10 averages the voice feature amounts extracted in the above-described period T4, determines whether there is a group corresponding to the averaged voice feature amount, and determines the speaker in accordance with the determination result. Accordingly, when the speaker is not clearly determined, the user terminal 10 appropriately determines the speaker after temporarily suspending the determination of the speaker and averaging the voice feature amount to some extent.

Further, the user terminal 10 displays the information related to the determined speaker on the display part 14 in association with the text information. Accordingly, the user terminal 10 displays the journal including the information on the speaker determined with high accuracy.

In particular, by displaying the journal including the information on the speaker determined with high accuracy, the user terminal 10 causes the conference participants to understand contents of each utterance more accurately. For example, in a conference with foreign participants or a conference where many technical terms are used, the user terminal 10 makes the participants understood unfamiliar language and difficult terms more deeply to prevent possible interruption of the conference by the participants listening back the unheard parts, thus achieving smooth proceeding of the conference.

Further, the user terminal 10 displays the information related to the classification name or the name of the speaker, displays the text information corresponding to each speaker by color-coding, or displays the text information corresponding to each speaker in word balloons. Thus, the user terminal 10 displays the speaker information by various display methods.

Note that the present invention is not limited to the embodiment described above, and various changes, improvements, and the like are possible within the scope of the appended claims.

For example, the above-described embodiment has described the case, as the example, where the controller 11 acquires data related to the voice input to the voice input part 16. However, the present embodiment is not limited to such a case. The controller 11 may acquire, for example, data related to voice in the past 4(1 conferences stored in the storage part 12 or the like. Accordingly, the user terminal 10 can determine the speaker in the past conference with high accuracy when it is necessary to display the journal of the past conference.

Further, the above-described embodiment has described the case, as the example, where the controller 11 generates the group of voice feature amounts for each speaker in accordance with the voice data acquired before the start of the conference. However, the present embodiment is not limited to such a case. Alternatively, the controller 11 may regenerate the group predetermined every fourth time. The fourth time may be, for example about 5 minutes. Accordingly, the controller 11 can improve the determination accuracy of the speaker. Note that the controller 11 may regenerate the group in accordance with the feedback from the creator of the journal.

Further, the embodiment described above has described the case, as the example, where the controller 11 executes the processing of step S203 after executing the processing of step S202, and executes the processing of step S207 after executing the processing of step S203 in the processing illustrated in FIG. 5. However, the present embodiment is not limited to such a case. Alternatively, the controller 11 may omit at least one of steps S202, S203, and S207. For example, when the controller 11 executes only the processing step S202 and determines that the extraction of the voice feature amount of the speaker Q has not been continued, the controller it may proceed straight to the processing of step S209 and determines that the speaker has not been switched. Alternatively, when the controller 11 executes only the processing of step S203 and determines that the predetermined word has been uttered, the controller 11 may proceed to the processing of step S204. When it is determined that the predetermined word has not been tittered, the controller It may proceed to the processing of step S209. As described above, the controller 11 can accurately determine whether the speaker has been switched from various viewpoints, and can also reduce the processing amount.

Further, the above-described embodiment has described the case, as the example, where the controller 11 21) determines the speaker before individual timing and the speaker after individual timing in the processing illustrated in FIGS. 6A and 6B. However, the present embodiment is not limited to such a case. Alternatively, the controller 11 may determine only speakers who have finished speaking before the timing of executing the processing illustrated in of FIGS. 6A and 6B. That is, the controller 11 may omit at least one of steps S306, S308, S311, and S313, for example, in the processing illustrated in FIG. 6A. Accordingly, the controller 11 can reduce the processing amount and quickly determine the speaker who has finished speaking.

Further, the above-described embodiment has described the case, as the example, where the controller 11 displays (outputs) the journal including the information on the speaker determined with high accuracy on the display part 14 that works as the outputter. However, the present embodiment is not limited to such a case. The controller 11 may cause any device working as the outputter to output the journal. For example, the controller 11 may transmit data of the journal to another user terminal, a projector, or the like, via the communication part 13 or the like to output the journal. Alternatively, the controller 11 may transmit the data of the journal as a printed matter to the image forming apparatus via the communication part 13 or the like.

(Modification)

The embodiment described above has described the case, as the example, where one user terminal 10 is used in the conference. In a modification, a case where a plurality of user terminals 10 are used is described.

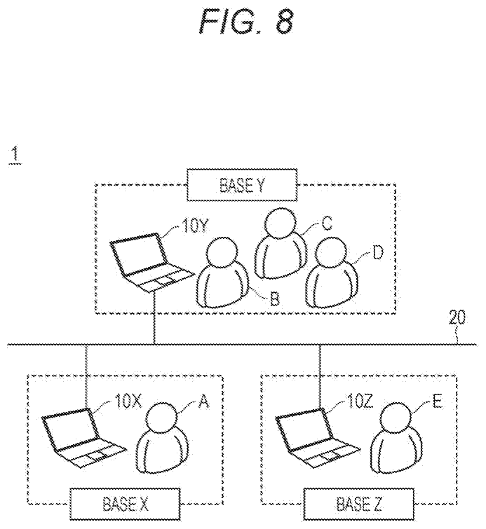

FIG. 8 is a diagram illustrating an overall configuration of the speaker determination system.

As illustrated in FIG. 8, a speaker determination system 1 includes a plurality of user terminals 10X, 10Y, and 10Z. The plurality of user terminals 10X, 10Y, and 10Z is located at a plurality of bases X, Y, and Z, and are used by a plurality of users A, B, C, D, and E, respectively. The user terminals 10X, 10Y, and 10Z each have a configuration similar to the configuration of the user terminal 10 according to the above-described embodiment, and are connected communicably with each other via a network 20 such as a LAN. The speaker determination system 1 may include constituent components other than the constituent components described above, or may not include some of the constituent components described above.

In the modification, any one of the user terminals 10X, 10Y, and 10Z functions as a speaker determination apparatus. For example, in the example illustrated in FIG. 8, the user terminal 10X may be a speaker determination apparatus, A may be the creator of the journal, and B, C, D, and E may be participants of the conference. Note that the speaker determination system 1 is independent of well-known video conference system, web conference system, and the like, and the user terminal 10X does not acquire information on the base of the speaker or the like from such systems.

The user terminal 10X as the speaker determination apparatus executes the above-described processing. However, the user terminal 10X acquires, as voice data, data related to voice input to the user terminals 10Y and 10Z from the user terminals 10Y and 10Z via the network 20 or the like. As a result, the user terminal 10X, can determine in real time, with high accuracy, B, C, and D who are speakers at the base Y, and E who is the speaker at the base Z.

Further, in the example described above, A may be the creator of the journal and a conference participant. In this case, the user terminal 10X acquires the data related to the voice input to the own device as the voice data, and also acquires the data related to the voice input to the user terminals 10Y and 10Z. Accordingly, the user terminal 10X can determine the speakers A, B, C, D, and E in real time with high accuracy.

As described above, in the speaker determination system 1 according to the modification, a plurality of user terminals is used, and data related to the voices of the speakers as a plurality of users is acquired by each user terminal, Accordingly, the speaker determination system 1 can discriminate and determine speakers with high accuracy even when the participants of the conference are located at a plurality of bases, Particularly in recent years, the opportunities for holding conferences (web conferences) via the network by people working at various bases have increased along with the development of remote work and network technology. The speaker determination system 1 can cause the participants of the conference to understand the contents of speech more accurately in such a recently increasing type of conference.

In particular, the speaker determination system 1 according to the modification can be independent from a known conference system such as a video conference system or a web conference system. Therefore, the speaker determination system 1 can determine the speaker with high accuracy in accordance with the individually acquired voice data, even when the conference is held using the conference system specified by the client, for example, and the speaker information is not directly acquired from the conference system. Further, the speaker determination system 1 may acquire the voice data acquired in the conference system from the conference system. Accordingly, the speaker determination system 1 can acquire voice data more easily while achieving higher convenience as a system independent of the conference system.

Note that the processing according to the embodiment described above may include steps other than the steps described above and may not include some of the steps described above. The order of the steps is not limited to that described in the above-described embodiment. Further, each step may be combined with another step to form one step, may be included in another step, or may be divided into a plurality of steps.

The means and method for performing various kinds of processing in the user terminal 10 as the speaker determination apparatus according to the above-described embodiment can be achieved by any of a dedicated hardware circuit and a programmed computer. The above-described program. may be provided in a computer-readable recording medium such as a compact disc read only memory (CD-ROM), or may be provided online via a network such as the Internet. In this case, the program recorded on the computer-readable recording medium is usually transferred to and stored in a storage part such as a hard disk. Further, the above-described program may be provided as one application software, or may be incorporated in the software of the apparatus as one function of the user terminal 10.

Although embodiments of the present invention have been described and illustrated in detail, the disclosed embodiments are made for purposes of illustration and example only and not limitation. The scope of the present invention should be interpreted by terms of the appended claims.

What is claimed is:

1. A speaker determination apparatus, comprising
a hardware processor that:
acquires data related to voice in a conference;
determines whether the voice has been switched in accordance with a feature amount of the voice extracted from the data related to the voice acquired by the hardware processor;
recognizes and converts the voice into text in accordance with the data related to the voice acquired by the hardware processor;
analyzes the text converted by the hardware processor and detects a sentence break in the text; and
determines a speaker in accordance with timing of the sentence break detected by the hardware processor and timing of the voice switching determined by the hardware processor.

2. The speaker determination apparatus according to claim 1, wherein
the hardware processor determines the speaker in accordance with a determination result of whether the sentence break timing and the voice switching timing match.

3. The speaker determination apparatus according to claim 2, wherein
when the hardware processor determines that the sentence break timing and the voice switching timing match, the hardware processor determines the speaker before the matched timing without relying on a text analysis result by the hardware processor.

4. The speaker determination apparatus according to claim 2, wherein
when the hardware processor determines that there is no match between the sentence break timing and the voice switching timing, the hardware processor determines the speaker in accordance with the text analysis result by the hardware processor.

5. The speaker determination apparatus according to claim 1, wherein
when the hardware processor is unable to determine the speaker according to the sentence break timing and the voice switching timing, the hardware processor determines that the speaker is unknown.

6. The speaker determination apparatus according to claim 1, wherein
the hardware processor detects the sentence break in accordance with a silent pail of the text or a structure of the sentence.

7. The speaker determination apparatus according to claim 1, wherein
the hardware processor temporarily determines a speaker who has uttered the voice in accordance with a feature amount of the voice, and
determines whether the speaker who is temporarily determined by the hardware processor is switched to determine Whether the voice is switched.

8. The speaker determination apparatus according to claim 7, wherein
the hardware processor generates, for each speaker, a group of the feature amount of the voice acquired before the conference starts in accordance with the data related to the voice, extracts the feature amount of the voice in accordance with the data related to the voice acquired after the start of the conference, and identifies the group corresponding to the extracted feature amount of the voice to temporarily determine the speaker.

9. The speaker determination apparatus according to claim 8, wherein
the hardware processor determines whether predetermined first time has passed after a start of acquisition of data related to the voice by the hardware processor before the start of the conference, and when it is determined that the first time has passed, determines the start of the conference.

10. The speaker determination apparatus according to claim 8, wherein
the hardware processor starts acquisition of data, related to the voice before the start of the conference, and
starts analysis of the text before the start of the conference, determines whether a word indicating the start of the conference is uttered and, when it is determined that the word indicating the start of the conference is uttered, determines the start of the conference.

11. The speaker determination apparatus according to claim 8, wherein
when it is determined that feature amount of the extracted voice is changed from a first feature amount that is the feature amount of the voice of a first speaker who has been determined temporarily, to a second feature amount that is the feature amount of the voice of a second. speaker different from the first feature amount, the hardware processor further determines the presence of the feature amount corresponding to the second feature amount and, when it is determined that there is no group corresponding to the second feature amount, newly generates a group of the second feature amount.

12. The speaker determination apparatus according to claim 7, wherein
the hardware processor determines whether the extraction of the second feature amount has continued until predetermined second time has passed in a case where it is determined that the feature amount of the voice extracted by the hardware processor is changed from a first feature amount that is the feature amount of the voice of a first speaker who has been temporarily determined, to a second feature amount that is the feature amount of the voice of a second speaker different from the first feature amount, and
when it is determined that the extraction of the second feature amount has continued by the hardware processor, the hardware processor determines that the speaker is switched.

13. The speaker determination apparatus according to claim 7, wherein
when it is determined that feature amount of the voice extracted by the hardware processor is changed from a first feature amount that is the feature amount of the voice of a first speaker who has been determined temporarily, to a second feature amount that is the feature amount of the voice of a second speaker different from the first feature amount, the hardware processor determines whether a predetermined word has been uttered during predetermined second time, and
when it is determined that the predetermined word. has been tittered, by the hardware processor, the hardware processor determines that the speaker is switched.

14. The speaker determination apparatus according to claim 7, wherein
the hardware processor determines whether the feature amount of the extracted voice has changed from a first feature amount that is the feature amount of the voice of a first speaker who has been temporarily determined to a second feature amount that is the feature amount of the voice of a second speaker different from the first feature amount, and has returned to the first feature amount,
determines that the speaker has been switched when the hardware processor determines that no feature amount of the extracted voice returns to the first feature amount and is thither changed to a third feature amount that is the feature amount of the voice of a third speaker different from the first feature amount and the second feature amount, and
determines that no speaker has been switched when the hardware processor determines that the feature amount of the extracted voice has returned to the first feature amount.

15. The speaker determination apparatus according to claim 14, wherein
the hardware processor determines whether the sentence break is detected by the hardware processor in a first period between first timing, at which the feature amount of the extracted voice changes from the first feature amount to the second feature amount, and second timing at which the second feature amount changes to the third feature amount.

16. The speaker determination apparatus according to claim 15, wherein
the hardware processor determines that,
when it is determined that one sentence break of the sentence is detected in the first period, the speaker before the timing of the one sentence break is the first speaker and the speaker after the timing of the one sentence break is the third speaker, and
when it is determined that a plurality of sentence breaks is detected in the first period, the speaker before the first timing is the first speaker, the speaker during the first period is unknown, and the speaker after the second timing is the third speaker.

17. The speaker determination apparatus according to claim 15, wherein
when it is determined that no sentence break is detected in the first period, the hardware processor determines that the speaker before the sentence break timing provided before the first timing is the first speaker, and temporarily suspends the determination of the speaker after the sentence break timing provided before the first timing,
when the determination of the speaker is suspended by the hardware processor, the hardware processor averages the feature amounts of the voice extracted in a second period between the sentence break timing provided before the first timing and the next sentence break timing, and determines whether there is a group of the feature amount of the voice for each speaker corresponding to the averaged feature amount of the voice, and
the hardware processor further determines that,
when the hardware processor determines that there is the group corresponding to the averaged feature amount of the voice, the speaker in the second period is the speaker corresponding to the group, and
when the hardware processor determines that there is no group corresponding to the averaged feature amount of the voice, the speaker in the second period is unknown.

18. The speaker determination apparatus according to claim 1, further comprising:
an output controller that causes an outputter to output information related to the speaker determined by the hardware processor in association with information related to the text.

19. The speaker determination apparatus according to claim 18, wherein
the output controller controls the outputter to output information related to a classification name or a name of the speaker, output information related to the text corresponding to each speaker by color-coding, or output information related to the text corresponding to each speaker in a word balloon to output the information related to the speaker.

20. A speaker determination method, comprising:
acquiring data related to voice in a conference;
determining whether the voice is switched in accordance with a feature amount of the voice extracted from the data related to the voice acquired in the acquiring;
recognizing the voice and converting the recognized voice into text in accordance with the data related to the voice acquired in the acquiring;
analyzing the text converted in the converting and detecting a sentence break in the text; and
determining a speaker in accordance with timing of the sentence break detected in the detecting and timing of the voice switching determined in the determining.

21. A non-transitory recording medium storing a computer readable control program of a speaker determination apparatus that determines a speaker, the control program causing a computer to perform:
acquiring data related to voice in a conference;
determining whether the voice is switched in accordance with a feature amount of the voice extracted from the data related to the voice acquired in the acquiring;
recognizing the voice and converting the recognized voice into text in accordance with the data related to the voice acquired in the acquiring;
analyzing the text converted in the converting and detecting a sentence break in the text; and
determining a speaker in accordance with timing of the sentence break detected in the detecting and timing of the voice switching determined in the determining.
